(19) United States
(12) Patent Application Publication
(10) Pub. No.: US 2017/0193218 A1
(43) Pub. Date: Jul. 6, 2017

(54) Reducing Unregulated Aggregation Of App Usage Behaviors

(71) Applicant: THE REGENTS OF THE UNIVERSITY OF MICHIGAN, Ann Arbor, MI (US)

(72) Inventors: Kang G. SHIN, Ann Arbor, MI (US); Huan FENG, Ann Arbor, MI (US)

(21) Appl. No.: 15/378,584

(22) Filed: Dec. 14, 2016

Related U.S. Application Data
(60) Provisional application No. 62/273,068, filed on Dec. 30, 2015.

(51) Int. Cl. G06F 21/52; G06F 21/62

(52) U.S. Cl. CPC G06F 21/52; G06F 21/6245

(57) ABSTRACT

The privacy threat of unregulated aggregation is addressed from a new perspective by monitoring, characterizing and reducing the underlying linkability across apps. This allows one to measure the potential threat of unregulated aggregation during runtime and promptly warn users of the associated risks. It was observed how real-world apps abuse OS-level information and IPCs to establish linkability. A practical countermeasure provides runtime monitoring and mediation of linkability across apps, introducing a new dimension to privacy protection on mobile device. An evaluation on real users has shown that proposed countermeasures are effective in reducing the linkability across apps and only incurs marginal overheads.

### CROSS-REFERENCE TO RELATED APPLICATIONS

This application claims the benefit of U.S. Provisional Application No. 62/273,068, filed on Dec. 30, 2015. The entire disclosure of the above application is incorporated herein by reference.

### FIELD

The present disclosure relates to techniques for reducing unregulated aggregation of app usage behaviors.

### BACKGROUND

Mobile users run apps for various purposes, and exhibit very different or even unrelated behaviors in running different apps. For example, a user may expose his chatting history to WhatsApp, mobility traces to Maps, and political interests to CNN. Information about a single user, therefore, is scatted across different apps and each app acquires only a partial view of the user. Ideally, these views should remain as “isolated islands of information” confined within each of the different apps. In practice, however, once the users' behavior information is at the hands of the apps, it may be shared or leaked in an arbitrary way without the users' control or consent. This makes it possible for a curious adversary to aggregate usage behaviors of the same user across multiple apps without his knowledge and consent, which we refer to as unregulated aggregation of app-usage behaviors.

In the current mobile ecosystem, many parties are interested in conducting unregulated aggregation. Advertising agencies embed ad libraries in different apps. establishing an explicit channel of cross-app usage aggregation. For example, Grindr is a geosocial app geared towards gay users, and BabyBump is a social network for expecting parents. Both apps include the same advertising library, MoPub, which can aggregate their information and recommend related ads, such as on gay parenting books. However, users may not want this type of unsolicited aggregation, especially across sensitive aspects of their lives,

Surveillance agencies monitor all aspects of the population for various precautionary purposes, some of which may cross the ‘red line’ of individuals' privacy. It has been widely publicized that NSA and GCHQ are conducting public surveillance by aggregating information leaked via mobile apps, including popular ones such as Angry Birds. A recent study shows that a similar adversary is able to attribute up to 50% of the mobile traffic to the “monitored” users, and extract detailed personal interests, such as political views and sexual orientations.

IT Companies in the mobile industry frequently acquire other app companies, harvesting vast user base and data. Yahoo alone acquired more than 10 mobile app companies in 2013, with Facebook and Google following closely behind 2013. These acquisitions allow an IT company to link and aggregate behaviors of the same user from multiple apps without the user's consent. Moreover, if the acquiring company (such as Facebook) already knows the users' real identities, usage behaviors of all the apps it acquires becomes identifiable.

These scenarios of unregulated aggregation are realistic, financially motivated, and are only becoming more prevalent in the foreseeable future. In spite of this grave privacy threat, the process of unregulated aggregation is unobservable and works as a black box—no one knows what information has actually been aggregated and what really happens in the cloud. Users, therefore, are largely unaware of this threat and have no opt-out options. Existing proposals disallow apps from collecting user behaviors and shift part of the app logic (e.g., personalization) to the mobile OS or trusted cloud providers. This, albeit effective, is against the incentive of app developers and requires construction of a new ecosystem. Therefore, there is a need for a practical solution that is compatible with the existing mobile ecosystem.

This section provides background information related to the present disclosure which is not necessarily prior art.

### SUMMARY

This section provides a general summary of the disclosure, and is not a comprehensive disclosure of its full scope or all of its features.

A computer-implemented method is presented for identifying usage behavior amongst applications on a computing device. The method includes: instrumenting a component of an operating system with an app monitor, where the operating system is executing on the computing device; detecting, by the app monitor, access to certain identifying information for a user of a given application, where the given application accesses the certain identifying information during runtime of the given application; accessing, by the app monitor, a linkability graph stored in a data store of the computing device, where the linkability graph is an undirected graph having a plurality of nodes, where each node represents an application installed on the computing device and each node specifies identifying information accessible to the corresponding application; identifying, by the app monitor, nodes in the linkability graph that specify the certain identifying information accessed by the given application; and creating, by the app monitor, an edge between node representing the given application in the linkability graph and each of the identified nodes in the linkability graph.

In one aspect, the method includes detecting installation of an application of the computing device; and creating a node in the linkability graph, where the node represents the application.

In another aspect, the method includes detecting communication between the given application and a second application installed on the computing device; and creating an edge between node representing the given application and node representing the second application.

In yet another aspect, the method includes detecting installation of the given application on the computing device; receiving identifier for the given application; encoding the identifier to form a masked identifier; and storing the masked identifier in a data store.

The method may also include notifying the user of the given application that the given application is accessing identifying information for the user, where notifying the user is performed in response to detecting access to certain identifying information for a user of a given application. The notification to the user includes a prompt to allow access to the identifying information for the user and a prompt to deny access to the identifying information for the user.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of an example dynamic linkability graph.

FIG. 2 is a diagram showing where to instrument system services using the Wi-Fi service as an example.

FIG. 3 is a diagram showing an extension to the centralized intent filter in Android to intercept all the intents across apps.

FIG. 4 is a diagram showing where to instrument Content Provider (shaded region) to record which app accessed which database with what parameters.

FIG. 5 is a diagram showing how to customize the FUSE daemon to intercept apps' access to shared external storage.

FIG. 6 is a flowchart depicting an example method for identifying usage behavior amongst applications.

FIG. 7 is a graph showing the percentage of apps accessing each source, and the linkability (LR) an app can get by exploiting each source.

FIG. 8 is a graph showing the (average) Linking Efforts (LE) of all the apps that are linkable due to a certain linkability source.

FIG. 9 is a diagram depicting a system that reduces unregulated aggregation of app usage behavior.

FIG. 10 is a diagram depicting a technique for obfuscating identifiers which is implemented by an agent of a linkability service.

FIG. 11 is an example user interface for prompting a user.

FIG. 12 is a diagram depicting implementation of an unlinkable mode by the linkability service.

FIG. 13 is a graph showing the Global Linking Ratio (GLR) of different categories of sources before and after using LinkDroid.

FIG. 14 is a graph showing the Global Linking Ratio (GLR) of different users before and after using LinkDroid.

FIG. 15A-B are diagrams depicting the DLG of a representative user before (a) and after (b) applying LinkDroid, respectively.

### Corresponding reference numerals indicate corresponding parts throughout the several views of the drawings.

### DETAILED DESCRIPTION

Example embodiments will now be described more fully with reference to the accompanying drawings.

In this disclosure, unregulated aggregation is targeted across app-usage behaviors, i.e., when an adversary aggregates usage behaviors across multiple functionally-independent apps without users' knowledge or consent. In the threat model, an adversary can be any party that collects information from multiple apps or controls multiple apps, such as a widely-adopted advertising agency, an IT company in charge of multiple authentic apps, or a set of malicious colluding apps. The mobile operating system and network operators are assumed trustworthy and will not collude with the adversary.

There are many parties interested in conducting unregulated aggregation across apps. In practice, however, this process is unobservable and works as a black box—no one knows what information an adversary has collected and whether it has been aggregated in the cloud. Existing studies propose to disable mobile apps from collecting usage behaviors and shift part of the app logic to trusted cloud providers or mobile OS. These solutions, albeit effective, require budding a new ecosystem and greatly restrict functionalities of the apps. Here, unregulated aggregation is addressed from a very different angle by monitoring, characterizing and reducing the underlying linkability across mobile apps. Two apps are linkable if they can associate usage behaviors of the same user. This linkability is the prerequisite of conducting unregulated aggregation, and represents an “upper-bound” of the potential threat. In the current mobile app ecosystem, there are various sources of linkability that an adversary can exploit. Researchers have studied linkability under several domain-specific scenarios, such as movie reviews and social networks. Here, focus is on the linkability that is ubiquitous and domain-independent. Specifically, contributing sources are grouped into the following two fundamental categories.

The first category is OS-level Information. The mobile OS provides apps ubiquitous access to various system information, many of which can be used as consistent user identifiers across apps. These identifiers can be device-specific, such as MAC address and NEI, user-specific, such as phone number or account number, or context-based, such as location or IP clusters. A longitudinal measurement study was conducted from March 2013 to January 2015, on the top 100 free Android apps in each category. Apps that are rarely downloaded were excluded, and only those with more than 1 million downloads were considered. Apps are getting increasingly interested in requesting persistent and consistent identifying information, as shown in Table 1 below.

| Type | 2013-3 | 2013-10 | 2014-8 | 2015-1 |
|---|---|---|---|---|
| Android | 80% | 84% | 87% | 91% |
| IMEI | 61% | 64% | 65% | 68% |
| MAC | 28% | 42% | 51% | 55% |
| Account | 24% | 29% | 32% | 35% |
| Contacts | 21% | 26% | 33% | 37% |

By January 2015, 96% of top free apps request both the Internet access and at least one persistent identifying information. These identifying vectors, either explicit or implicit, allow two apps to link their knowledge of the same user at a remote side without even trying to bypass on-device isolation of the mobile OS.

The second category is Inter-Process communications. The mobile OS provides explicit Inter-Process Communication (IPC) channels, allowing apps to communicate with each other and perform certain tasks, such as export a location from Browser and open it with Maps. Since there is no existing control on IPC, colluding apps can exchange identifying information of the user and establish linkability covertly, without the user's knowledge. They can even synchronize and agree on a randomly-generated sequence as a custom user identifier, without accessing any system resource or permission. This problem gets more complex since apps can also conduct IPC implicitly by reading and writing shared persistent storage (SD card and databases). As shown below, these exploitations are not hypothetical and have already been utilized by real-word apps.

The cornerstone of this work is the Dynamic Linkability Graph (DLG). It enables one to monitor app-level linkability during runtime and quantify the linkability introduced by different contributing sources. Linkability across different apps on the same device is modeled as an undirected graph, which is referred to herein as the Dynamic Linkability Graph (DLG). An illustrative example of a DLG is shown in FIG. 1. Nodes 11 in the DLG represent apps and edges 12 represent linkability introduced by different contributing sources. DLG monitors the linkability during runtime by tracking the apps' access to various OS-level information and IPC channels. An edge exists between two apps if they access the same identifying information or engage in an IPC.

DLG presents a comprehensive view of the linkability across all installed apps. An individual adversary, however, may only observe a subgraph of the DLG. For example, an advertising agency only controls those apps (nodes) that incorporate the same advertising library; an IT corporate only controls those apps (nodes) it has already acquired. This disclosure focuses on the generalized case (the entire DLG) instead of considering each adversary individually (subgraphs of DLG).

Two apps a and b are linkable if there is a path between them. In FIG. 1, app A and F are linkable, app A and H are not linkable. Gap is defined as the number of nodes (excluding the end nodes) on the shortest path between two linkable apps a and b. It represents how many additional apps an adversary needs to control in order to link information across a and b. For example, in FIG. 1, gap_{A,D}=0, gap_{A,E}=1, gap_{A,G}=2.

Linking Ratio (LR) of an app is defined as the number of apps it is linkable to, divided by the number of all installed apps. LR ranges from 0 to 1 and characterizes to what extent an app is linkable to others. In DLG, LR equals to the size of the Largest Connected Component (LCC) this app resides in, excluding itself, divided by the size of the entire graph, also excluding itself.

$${LR}_{a} = \frac{size ( {LCC}_{a} ) - 1}{size ( DLG ) - 1}$$

Linking Effort (LE) of an app is defined by the Linking Effort (LE) of an app as the average gap between it and all the apps it is linkable to. LEₐ characterizes the difficulty in establishing linkability with a. LEₐ=0 means that to link information from app a and any random app it is linkable to, an adversary does not need additional information from a third app.

$${LE}_{a} = {\sum }_{{b ∈ LCCa}_{b \neq a}} \frac{{gap}_{a , b}}{size ( {LCC}_{a} ) - 1}$$

LR and LE describe two orthogonal views of the DLG. In general, LR represents the quantity of links, describing the percentage of all installed apps that are linkable to a certain app, whereas LE characterizes the quality of links, describing the average amount of effort an adversary needs to make to link a certain app with other apps in FIG. 1,

$${LR}_{A} = 6 / 8 , {LR}_{H} = \frac{1}{8} ;$$

$${LE}_{A} = \frac{0 + 0 + 0 + 1 + 1 + 2}{7 - 1} = 4 / 6 , {LE}_{H} = 0.$$

Both LR and LE are defined for a single app. Similar definitions are also needed for the entire graph. Global Linking Ratio (GLR) and Global Linking Effort (GLE) are introduced. GLR represents the probability of two randomly selected apps being linkable, while GLE represents the number of apps an adversary needs to control to link two random apps.

$$GLR = {\sum }_{a} \frac{{LR}_{a}}{size ( DLG )}$$

$$GLE = \frac{1}{{\sum }_{a} size ( {LCC}_{a} ) - 1} {\sum }_{b} {\sum }_{{c ∈ {LCC}_{b}}_{c \neq b}} {gap}_{b , c}$$

In graph theory, GLE is also known as the Characteristic Path Length (CPL) of a graph, which is widely used in Social Network Analysis (SNA) to characterize whether the network is easily negotiable or not. While reference has been made to a few particular metrics, it is understood that other types of metrics quantifying linkability also fall within the scope of this disclosure.

DLG maintains a dynamic view of app-level linkability by monitoring runtime behaviors of the apps. Specifically, it keeps track of apps' access to device-specific identifiers (e.g., IMEI Android ID, MAC), user-specific identifiers (e.g., phone number, accounts, subscriber ID, ICC serial number), and context-based information (e.g., IP address, nearby APs, location). It also monitors explicit IPC channels (Intent, Service Binding) and implicit IPC channel (Indirect RW, i.e., reading and writing the same file or database). This is not an exhaustive list but covers the most standard and widely-used aggregating channels. Table 2 below presents a list of example contributing sources considered in this disclosure.

| Category | Type | Source |
|---|---|---|
| OS-level Info. | Device | IMEI |
| | | Android ID |
| | | MAC |
| | Personal | Phone # |
| | | Account |
| | | Subscriber ID |
| | | ICC Serial # |
| | Contextual | IP |
| | | Nearby Aps |
| | | Location (POIs) |
| IPC Channel | Explicit | Intent |
| | | Service Binding |
| | Implicit | Indirect RW |

While reference is made to particular identifiers, it is understood that other types of identifiers also fall within the scope of this disclosure.

The criterion of two apps being linkable differs depending on the linkability source. For consistent identifiers that are obviously unique—Android ID, IMEI, Phone Number, MAC, Subscriber ID, Account, ICC Serial Number—two apps are linkable if they both access the same type of identifier. For pair-wise IPCs—intents, service bindings, and indirect RW—the two communicating parties involved are linkable. For implicit and fuzzy information, such as location, nearby APs, and IP, there are known ways to establish linkability as well. For example, user-specific location clusters (Points of Interests, or Pols) is already known to be able to uniquely identify a user. Therefore, an adversary can link different apps by checking whether the location information they collected reveal the same Pols. Here, the Pols are extracted using a lightweight algorithm as used, for example in Lightweight Extraction of Frequent Spatio-Temporal Activities from GPS Traces, by A. Bamis and A. Savvides in IEEE Real-Time Systems Symposium (2010), pp. 281-291 and Location privacy protection for smartphone users, by K. Fawaz and K. G. Shin, in Proceedings of the 2014 ACM SIGSAC Conference on Computer and Communications Security (2014), ACM, pp. 239-250 and is incorporated by reference herein. In an example embodiment, the top 2 Pols are selected as the linking standard, which typically correspond to home and work addresses. Similarly, the consistency and persistence of a user's Pols are also reflected on its AP clusters and frequently-used IP addresses. This property allows one to establish linkability across apps using these fuzzy contextual information.

DLG gives us the capability to construct cross-app linkability from runtime behaviors of the apps. By way of example, linkability can be implemented as an extension to current mobile operating systems, using Android as an illustrative example. Other implementation options, such as user-level interception (Aurasium) or dynamic OS instrumentation (Xposed Framework) are also contemplated by this disclosure. The former is insecure since the extension resides in the attacker's address space and the latter is not comprehensive because it cannot handle the native code of an app. However, a developer can always implement a useful subset of DLG using one of these more deployable techniques.

Android is a Linux-based mobile OS developed by Google. By default, each app is assigned a different Linux uid and lives in its own sandbox. Inter-Process Communications (IPCs) are provided across different sandboxes, based on the Binder protocol which is inherently a lightweight RPC (Remote Procedure Call) mechanism. There are four different types of components in an Android app: Activity, Service, Content Provider, and Broadcast Receiver. Each component represents a different way to interact with the underlying system: Activity corresponds to a single screen supporting user interactions; Service runs in the background to perform long-running operations and processing; Content Provider is responsible for managing and querying of persistent data such as database; and Broadcast Receiver listens to system-wide broadcasts and filters those it is interested in. The Android framework can be instrumented to monitor app's interactions with the system and each other via these components.

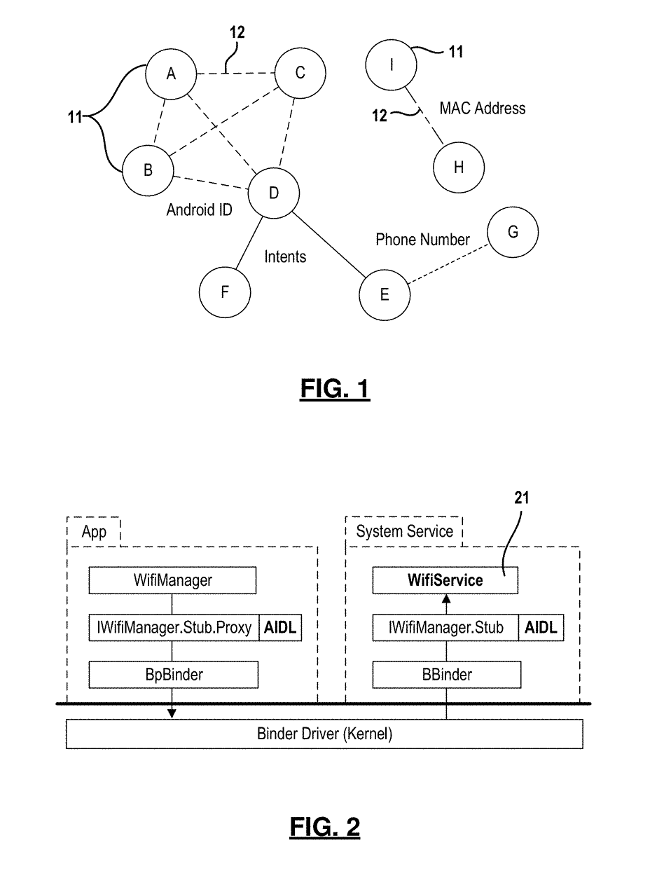

In order to construct a DLG in Android, apps' need to track access to various OS-level information as well as IPCs between apps. Apps access most identifying information, such as IMEI and MAC, by interacting with different system services. These system services are parts of the Android framework and have clear interfaces defined in AIDL (Android Interface Definition Language). By instrumenting the public functions in each service that return persistent identifiers, a timestamped record is constructed of which app accessed what type of identifying information via which service. FIG. 2 illustrate a detailed view of where to instrument using the Wi-Fi service as an example. In this example, the system service 21, WifiService, is instrumented. It is readily understood that other types of system services can be instrumented in a similar manner.

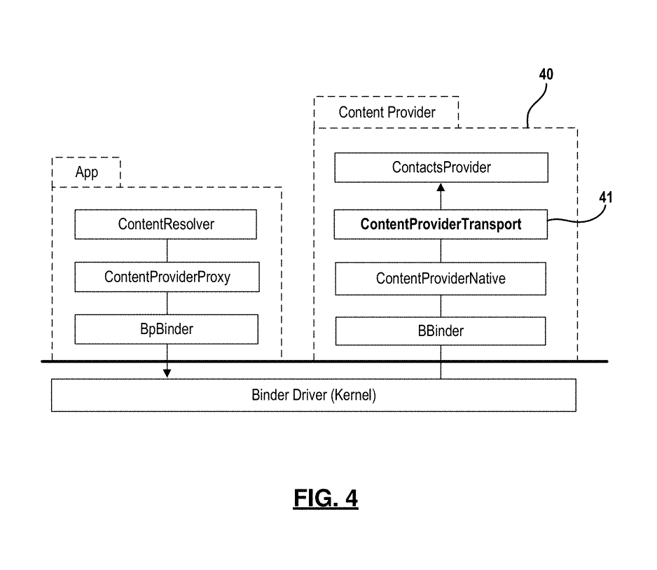

In another example, apps access some identifying information, such as Android ID, by querying system content providers. Android framework has a universal choke point for all access to remote content providers—the server-side stub class ContentProvider.Transport. FIG. 4 illustrates how an app accesses remote Content Provider 40 and explains which part to modify in order to log the information needed. By instrumenting the ContentProvider.Transport class 41, it can be discovered which database (uri) an app is accessing and with what parameters and actions. It is envisioned that content providers in other operating systems can be instrumented in a similar manner.

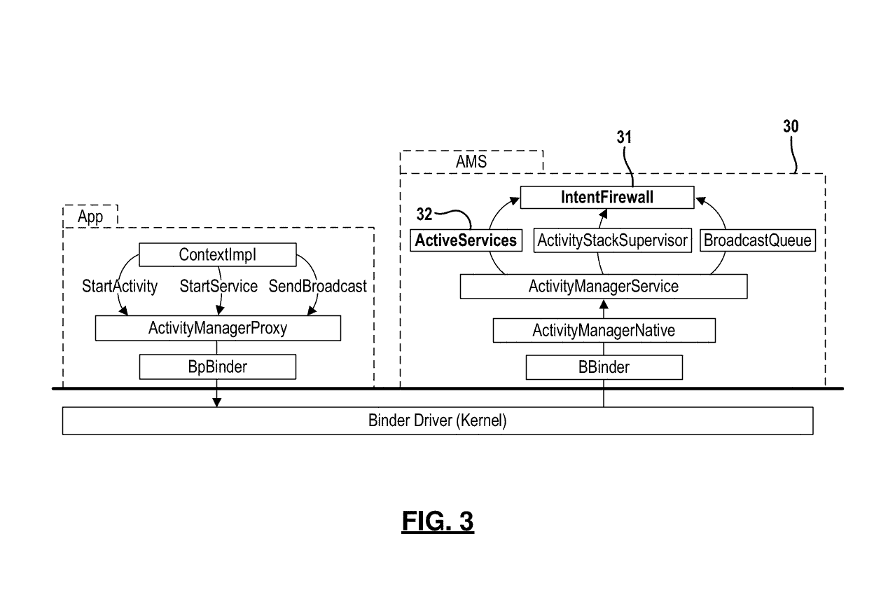

Apps can launch IPCs explicitly, using Intents. Intent is an abstract description of an operation to be performed. It can either be sent to a specific target (app component), or broadcast to the entire system. Android has a centralized filter which enforces system-wide policies for all Intents. This filter 31 (com.android.serverfirewall.IntentFirewall) is extended to record and intercept all Intent communications across apps as seen in FIG. 3. In addition to Intents, Android also allows an app to communicate explicitly with another app by binding to one of the services it exports. Once the binding is established, the two apps can communicate under a client-server model. In this example, the com.android.server.am.Active Services 32 in the Activity Manager 30 is instrumented to monitor all the attempts to establish service bindings across apps.

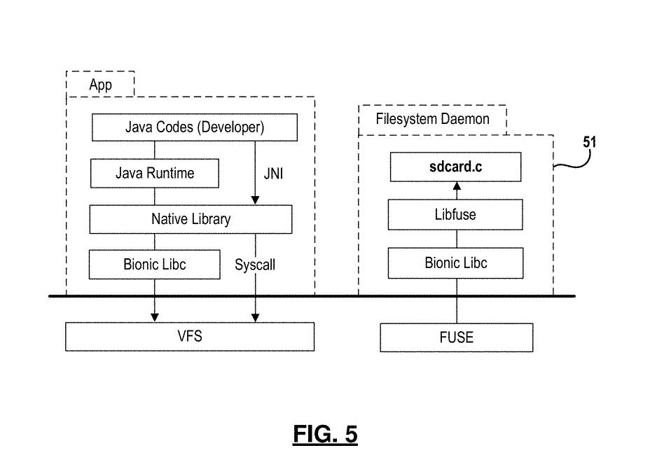

Apps can also conduct IPCs implicitly by exploiting shared persistent storage. For example, two apps can write and read the same file in the SD card to exchange identifying information. Therefore, there is also a need to monitor read and write access to persistent storage. External storage in Android are wrapped by a FUSE (Filesystem in Userspace) daemon which enables user-level permission control. By modifying this daemon 51, one can track which app reads or writes which files as seen in FIG. 5. This allows one to implement a Read-Write monitor which captures implicit communications via reading a file which has previously been written by another app. Besides external storage, the Read-Write monitor also considers similar indirect communications via system Content Providers.

Techniques for monitoring the different ways an app can interact with system components (Services, Content Providers) and other apps (Intents, service bindings, and indirect RW) has been described above in the context of Android. This methodology is fundamental and can be extended to cover other potential linkability sources as long as a dear definition is given. In an example embodiment, each linkability source is instrumented with a different app monitor, where the app monitor is implemented by a set of computer readable instructions executable by a processor of the host device. By placing app monitors at the aforementioned locations in the system framework, one gets all the information needed to construct a DLG.

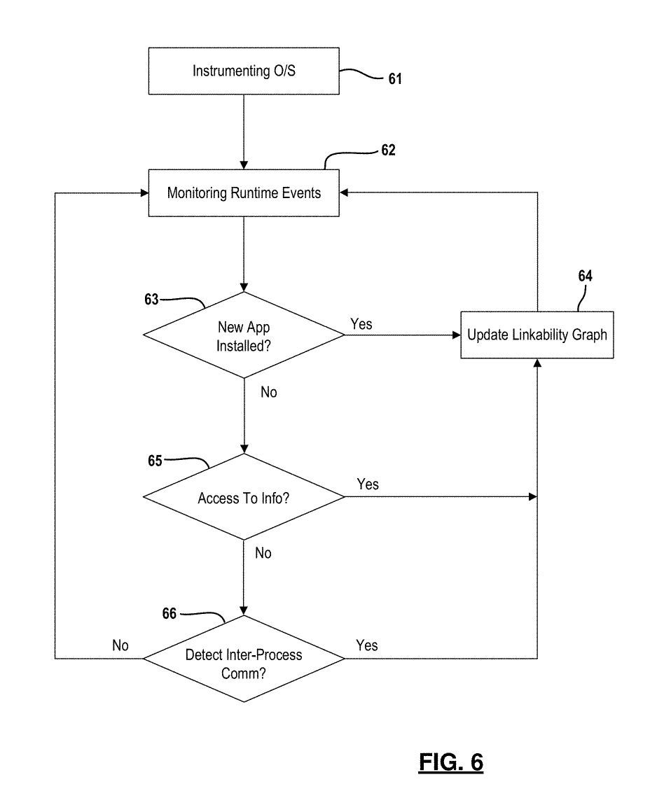

FIG. 6 further illustrates the methodology for identifying usage behavior amongst applications on a host computing device. First, one or more components of an operating system are instrumented at 61 with an app monitor, where the app monitor is implemented by computer-executable instructions executed by a processor of the host computing device. Examples of how to instrument the Android operating system were set forth above. These are understood to be illustrative and can be extended to other types of operating systems. Techniques for instrumenting OS components are readily known in the art and fall outside the scope of this disclosure.

To construct and maintain the linkability graph, various runtime events occurring on the host computing device are monitored as indicated at 62. For example, a linkability service monitors and detects installation of applications on the host computing device as indicated at 63. In one embodiment, the linkability service is implemented in a manner similar to other monitoring services of the host operating system.

Upon detecting installation of a new application, the linkability service will update at 64 a linkability graph stored in a data store of the computing device. Specifically, the linkability service creates a node in the linkability graph, where the node represents the newly installed application. As noted above, the linkability graph is an undirected graph having a plurality of nodes, where each node represents an application installed on the computing device and each node specifies identifying information accessible to the corresponding application. Likewise, the linkability graph can detect when an application is uninstalled and remove the corresponding node from the linkability graph. In this way, nodes in the linkability graph are maintained.

Access to identifying information by an application is monitored at 65. In the example embodiment, one or more an app monitors instrumented in the operating system performs the monitoring function. Upon detecting access to certain identifying information for a user of a given application, the detecting app monitor will update the linkability graph at 64. In particular, the app monitor will identify nodes in the linkability graph that specify certain identifying information accessed by the given application and create an edge between the node representing the given application and each of the identified nodes in the linkability graph. In other embodiments, control may be passed from the app monitor to the linkability service (upon detecting access to certain identifying information) and the linkability service updates the linkability graph. It is envisioned that the given application may access two or more different types of identifying information. In one embodiment, the edge is created between nodes when a match occurs for one type identifying information (even if the other types of identifying information are mismatched). In other embodiments, the edge is created between nodes only when each type of identifying information is matched. Other rules for when to create an edge are also contemplated by this disclosure.

Inter-process communication is also monitored at 66. Upon detecting communication between two applications, the detecting app monitor will again update the linkability graph at 64. In this case, an edge is created in the linkability graph between the applications communicating with each other. For example, when app B establishes an IPC with app A, then an edge is created between the two nodes corresponding to app A and app B. In another example, when app B reads a file written by app A, an edge is created between the two nodes corresponding to app A and app B. It is to be understood that only the relevant steps of the method are discussed in relation to FIG. 6, but that other software-implemented instructions may be needed to control and manage the overall operation of the system.

Next, app-level linkability is studied in the real world. The method described above was prototyped on a Cyanogenmod 11 (based on Android 4.4.1) and installed the extended OS on 7 Samsung Galaxy W devices and 6 Nexus V devices. The study includes 13 participants. Of the 13 participants, 6 of the participants are females and 7 are males. Before using the experimental devices, 7 of them were Android users and 6 were iPhone users. Participants are asked to operate their devices normally without any extra requirement. Logs are uploaded once per hour when the device is connected to Wi-Fi. Built-in system apps were excluded (since the mobile OS is assumed to be benign in our threat model) and only third-party apps that are installed by the users themselves were considered.

During the study, a total of 215 unique apps were observed during a 47-day period for 13 users. On average, each user installed 26 apps and each app accessed 4.8 different linkability sources. It was noted that more than 80% of the apps are installed within the first two weeks after deployment, and apps would access most of the linkability sources they are interested in during the first day of their installation. This suggests that a relative short-term (a few weeks) measurement would be enough to capture a representative view of the problem.

Measurements indicate an alarming view of the threat: two random apps are linkable with a probability of 0.81, and an adversary only needs to control 2.2 apps (0.2 additional app), on average, to link them. This means that an adversary in the current ecosystem can aggregate information from most apps without additional efforts (i.e., controlling a third app). Specifically, it was found that 86% of the apps a user installed on his device are directly linkable to the Facebook app, namely, his real identity. This means almost all the activities a user exhibited using mobile apps are identifiable, and can be linked to the real person.

This vast linkability is contributed by various sources in the mobile ecosystem. Here, it is reported that the percentage of apps accessing each source and the linkability (LR) an app can acquire by exploiting each source. The results are provided in FIG. 7. Observe that except for device identifiers, many other sources contributed to the linkability substantially. For example, an app can be linked to 39% of all installed apps (LR=0.39) using only account information, and 36% (LR=0.36) using only Intents. The linkability an app can get from a source is roughly equal to the percentage of apps that accessed that source, except for the case of contextual information; IP, Location and Nearby Aps. This is because the contextual information an app collected does not always contain effectively identifying information. For example, Yelp is mostly used at infrequent locations to find nearby restaurants, but is rarely used at consistent Pols, such as home or office. This renders location information useless in establishing linkability with Yelp.

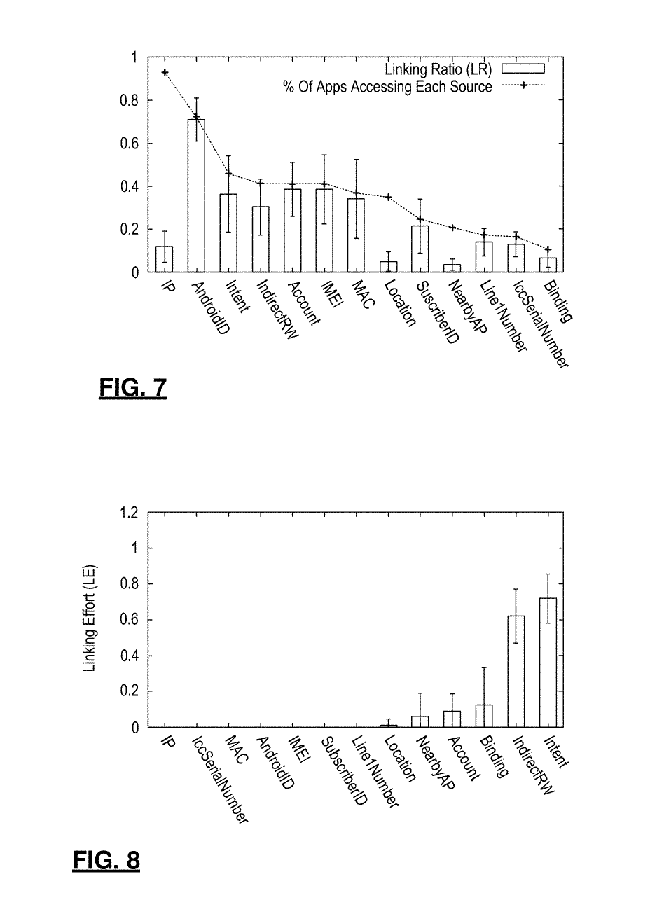

The effort required to aggregate two apps also differs for different linkability sources, as shown in FIG. 8. Device identifiers have LE=0, meaning that any two apps accessing the same device identifier can be directly aggregated without requiring control of an additional third app. Linking apps using IPC channels, such as Intents and Indirect RW, requires the adversary to control an average of 0.6 additional app as the connecting nodes. This indicates that, from an adversary's perspective, exploiting consistent identifiers is easier than building pair-wise associations.

The linkability sources are grouped into four categories—device, personal, contextual, and IPC—to assess the linkability contributed by each category (see Table 3). As expected, device-specific information introduces substantial linkability and allows the adversary to conduct across-app aggregation effortlessly. Surprisingly, the other three categories of linkability sources also introduce considerable linkability. In particular, only using fuzzy contextual information, an adversary can link more than 40% of the installed apps to Facebook, the user's real identity. This suggests the naive solution of anonymizing device ids is not enough, and hence a comprehensive solution is needed to make a trade-off between app functionality and privacy.

TABLE 3
Linkability contributed by different categories of sources.

| Category | GLR | GLE | LR_{Facebook} |
|---|---|---|---|
| Device | 0.52 (0.13) | 0.03 (0.03) | 0.68 (0.12) |
| Personal | 0.30 (0.10) | 0.30 (0.11) | 0.54 (0.11) |
| Contextual | 0.20 (0.13) | 0.33 (0.20) | 0.44 (0.25) |
| IPC | 0.32 (0.13) | 0.78 (0.06) | 0.59 (0.15) |

Device identifiers (IMEI, Android ID, MAC) introduce vast amount of linkability. 162 mobile apps that request these device-specific identifiers were manually evaluated but could rarely identify any explicit functionality that requires accessing the actual identifier. In fact, for the majority of these apps, their functionalities are device-independent, and therefore independent of device IDs. This indicates that device-specific identifier can be obfuscated across apps without noticeable loss of app functionality. The only requirement for device ID is that it should be unique to each device.

As to personal information (Account Number, Phone Number, Installed Apps, etc.), it was observed many unexpected access resulted in unnecessary linkability. It was also found that many apps that request account information collected all user accounts even when they only needed one to function correctly; many apps request access to phone number even when it is unrelated to their app functionalities. Since the legitimacy of a request depends both on the user's functional needs and the specific app context, end-users should be prompted about the access and make the final decision.

The linkability introduced by contextual information (Location, Nearby AP) also requires better regulation. Many apps request permission for precise location, but not all of them actually need it to function properly. In many scenarios, apps only require coarse-grained location information and shouldn't reveal any identifying points of interest (Dols). Nearby AP information, which is only expected to be used by Wi-Fi tools managing apps, is also abused for other purposes. It was noted that many apps frequently collect Nearby AP information to build an internal mapping between locations and access points (APs). For example, it was found that even if we turn off all system location services, WeChat (an instant messaging app) can still infer the user's location only with Nearby AP information. To reduce the linkability introduced by these unexpected usages, the users should have finer-grained control on when and how the contextual information can be used.

Moreover, it was found that IPC channels can be exploited in various ways to establish linkability across apps. Apps can establish linkability using Intents, sharing and aggregating app-specific information. For instance, it was observed that WeChat receives Intents from three different apps right after their installations, reporting their existence on the same device. Apps can also establish linkability with each other via service binding. For example, both AdMob and Facebook allow an app to bind to its service and exchanging the user identifier, completely bypassing the system permissions and controls. Apps can also establish linkability through Indirect RW, by writing and reading the same persistent file. The end-user should be promptly warned about these unexpected communications across apps to reduce unnecessary linkability.

Based on these observations and findings on linkability across real-world apps, a linkability service is proposed and referred to herein as LinkDroid. LinkDroid is designed with practicality in mind. Numerous extensions, paradigms and ecosystems have been proposed for mobile privacy, but access control (runtime for iOS and install-time for Android) is the only deployed mechanism. LinkDroid adds a new dimension to access control on smartphones and other computing devices. Unlike existing approaches that check if some app behavior poses direct privacy threats, LinkDroid warns users about how it implicitly builds the linkability across apps. This helps users reduce unnecessary links introduced by abusing OS-level information and IPCs, which happens frequently in reality as the measurement study set forth above indicated.

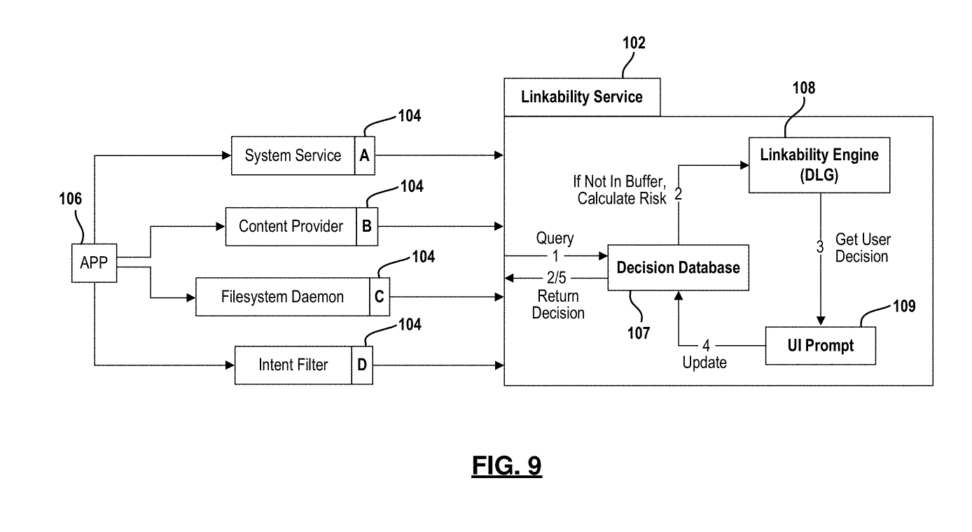

FIG. 9 provides an overview of a system that reduces unregulated aggregation of app usage behavior. The system 100 is primarily comprised of a linkability service 102 and one or app monitors 104. The app monitors 104 provides runtime monitoring and mediation of linkability by monitoring and intercepting app behaviors that may introduce linkability as well as queries the linkability service 102 to get the user's decision regarding app behavior. The linkability service 102 returns responses to queries from the app monitor 104, prompts a user about the potential risk associated with the app 106 and updates the linkability graph (DLG).

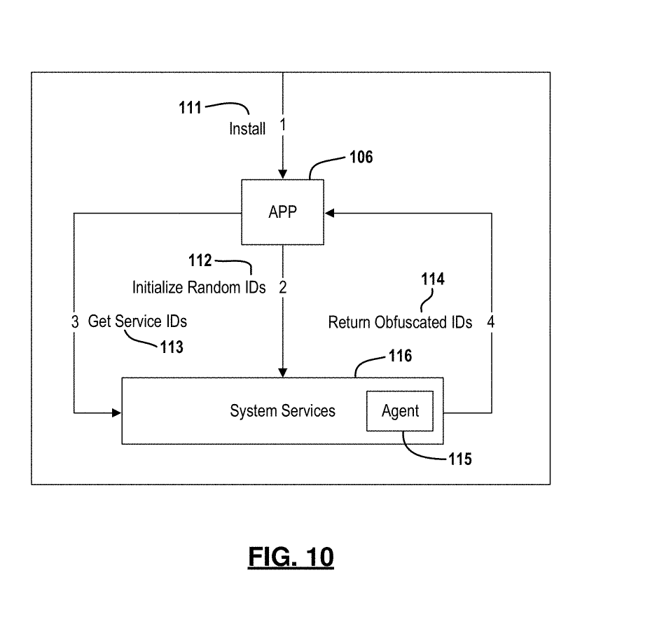

As mentioned earlier, app functionalities are largely independent of each device identifiers. This allows one to obfuscate these identifiers and cut off many unnecessary edges in the DLG. A technique for obfuscating identifiers is further described in relation to FIG. 10. In an example embodiment, the device identifiers of interest include IMEI, Android ID and MAC. Every time an app 106 gets installed at 111 the operating system receives a request at 112 to initialize device identifiers for the requesting app. The operating system in turn initializes the device identifiers and stored the device identifiers in a memory space associate with the requesting app 106.

In an example embodiment, an agent 115 is instrumented in the system service 116 of the operating system that is responsible for initializing the memory space for the requesting app 106. The initializing request is directed to the agent 115 who in turn encodes the device identifiers, for example using a hash function.

IDₜ^{a}=hash(IDₜ+maskₐ).

where the maskₐ is an application specific parameter, such as package name or install time. In this way, when an app a tries to fetch the device identifier of a certain type t at 113, the operating system will return at 114 an encoded value (e.g., a hash of the real identifier salted with the app-specific mask code). Other types of encoding methods fall within the scope of this disclosure. Note that this is done at install-time instead of during each session because one wants to guarantee the relative consistency of the device identifiers within each app. Otherwise, the app will think the user is switching to a different device and trigger some security/verification mechanism. It is envisioned that the user can always cancel this default obfuscation in a privacy manager if he finds it necessary to reveal real device identifiers to certain apps.

Except for device-specific identifiers, obfuscating other sources of linkability is likely to interfere with the app functionalities. Whether there is a functional interference or not is highly user-specific and context dependent. To make a useful trade-off, the user should be involved in this decision-making process. In an example embodiment, the linkability service will prompt a user before permitting an app to perform usage behavior.

Returning to FIG. 9, upon detecting certain app behavior which may lead to linkability, the app monitor 104 will query a decision database 107 maintained by the linkability service 102. For each installed app, the decision database 107 maintains a user decision whether to allow or deny the app behavior. The decision database 107 may contain a single decision for a given app or, more granularly, may contain a decision for each type of identifying information for which access is being sought. If the linkability service 102 cannot find an entry for the app in the decision database 107 it will issue a prompt at 109 to the user.

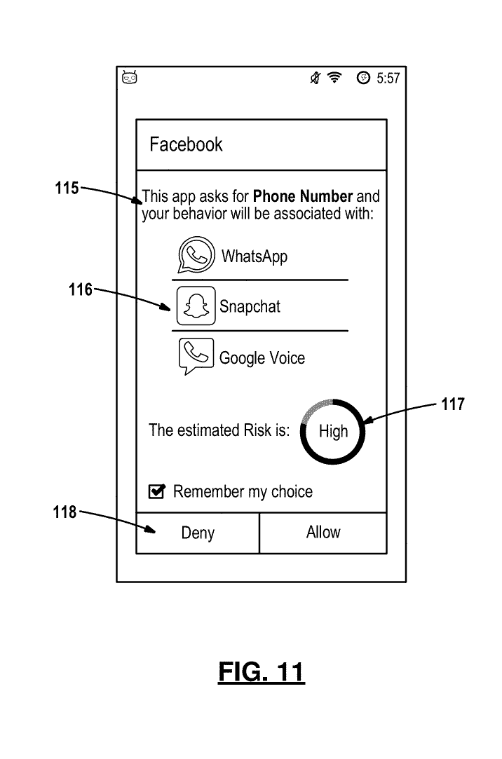

FIG. 11 depicts an example interface for the user prompt. Before the user can make a decision, he first needs to know what app behavior triggered the prompt. In one embodiment, two types of description are provided on the prompt: access to OS-level information and cross-app communications. To help the user understand the situation, high-level descriptive language is used as indicated at 115 instead of the exact technical terms. For example, when an app tries to access Subscriber ID or IccSerialNumber, the prompt reports that “App X asks for sim-card information.” When an app tries to send Intents to other apps, the prompt reports that “App X tries to share content with App Y”.

Additionally, two types of risk indicators are reported to users: one is descriptive and the other is quantitative. The descriptive indicator 116 tells what apps will be directly linkable to an app if the user allows its current behavior; ‘directly linkable’ means without requiring a third app as the connecting nodes. In the example embodiment, the listing of apps can be determined by the linkability service 102 from the DLG (e.g., a node directly linked to the app and/or one step away from the app).

The quantitative indicator 117, on the other hand, reflects the influence on the overall linkability of the running app, including those apps that are not directly linkable to it. In the example embodiment, the overall linkability is reported as a combination of the linking ratio (LR) and linking effort (LE):

Lₐ=LRₐ×e^{-LE}^{ₐ}.

The quantitative risk indicator is defined as ΔLₐ. A user will be warned of a larger risk if the total number of linkable apps significantly increases, or the average linking effort decreases substantially. In the example embodiment, the quantitative risk is transformed linearly into a scale of four and reported as Low, Medium, High, and Severe risk. Other methods for quantifying risk are also contemplated by this disclosure.

In response to the prompt, the user has at least two options: Allow or Deny as indicated at 118. If the user chooses Allow, the app behavior is permitted. On the other hand, if the user chooses Deny, the linkability service 102 will take some type of protective measure. In most instances, the linkability service 102 will obfuscate the information this app tries to get or shut down the communication channel this app requests. For some types of identifying information, such as Accounts and Location, different measures may be taken. For location information, the user can choose to share less precise information such as zip-code level (1 km) or city-level (10 km) information, For account information, the user can choose which specific account he wants to share instead of exposing all his accounts. The linkability service also allows the user to set up a VPN (Virtual Private Network) service to anonymize network identifiers. When the user switches from a cellular network to Wi-Fi, the linkability service can automatically initialize the VPN service to hide the user's public IP. These protective measures are merely illustrative and not limiting of the types of protective measures that can be implemented by the linkability service.

In either case, the user's decision to allow or deny the app behavior is stored in the decision database 107 for further use. The next time an app monitor 104 queries the decision database 107 for the same app, the user's previously stored decision will govern the action taken by the linkability service 102. The linkability service 102 may also provide a centralized privacy manager such that the user can review and change all previously made decisions.

Once a link is establish in DLG, it cannot be removed. This is because once a piece of identifying information is accessed or a communication channel is established, it can never be revoked. However, the user may sometimes want to perform privacy-preserving tasks which have no interference with the links that have already been introduced. For example, when the user wants to write an anonymous post in Reddit, he doesn't want it to be linkable with any of his previous posts as well as other apps. In some embodiments, the linkability service 102 provides an unlinkable mode to meet such a need.

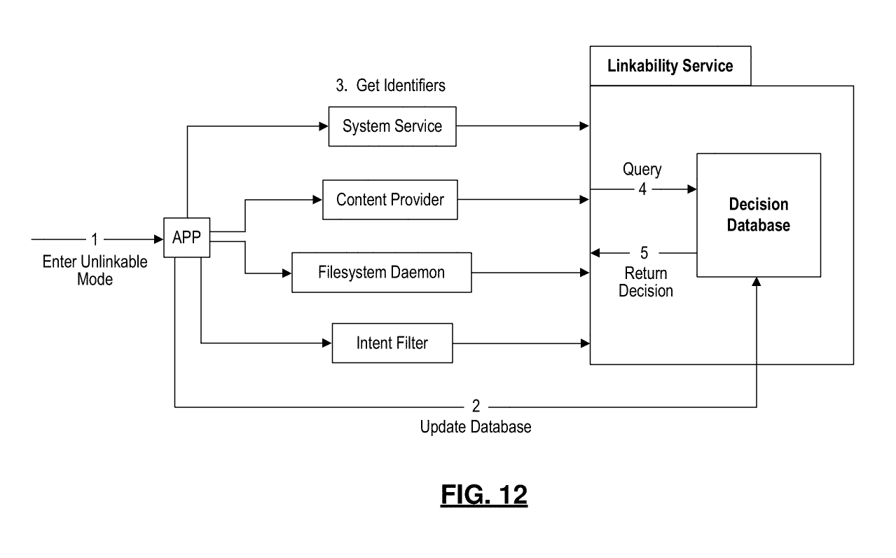

Referring to FIG. 12, a user can start an app in unlinkable mode by pressing its icon in the app launcher. A new uid as well as isolated storage will be allocated to this unlinkable app instance. By default, access to all OS-level identifying information and inter-app communications will be denied. This way, the linkability service creates the illusion that this app has just been installed on a brand-new device. The unlinkable mode allows the linkability service to provide finer-grained (session-level) control, unlinking only a certain set of app sessions.

LinkDroid is evaluated in terms of its overheads in usability and performance, as well as its effectiveness in reducing linkability. The overhead of LinkDroid mainly comes from two parts: the usability burden of dealing with UI prompts and the performance degradation of querying the linkability service. Experimental results show that, on average, each user was prompted only 1.06 times per day during the 47-day period. The performance degradation introduced by the linkability service is also marginal. It only occurs when apps access certain OS-level information or conduct cross-app IPCs. These sensitive operations happened rather infrequently—once every 12.7 seconds during experiments. These results suggest that LinkDroid has limited impact on system performance and usability.

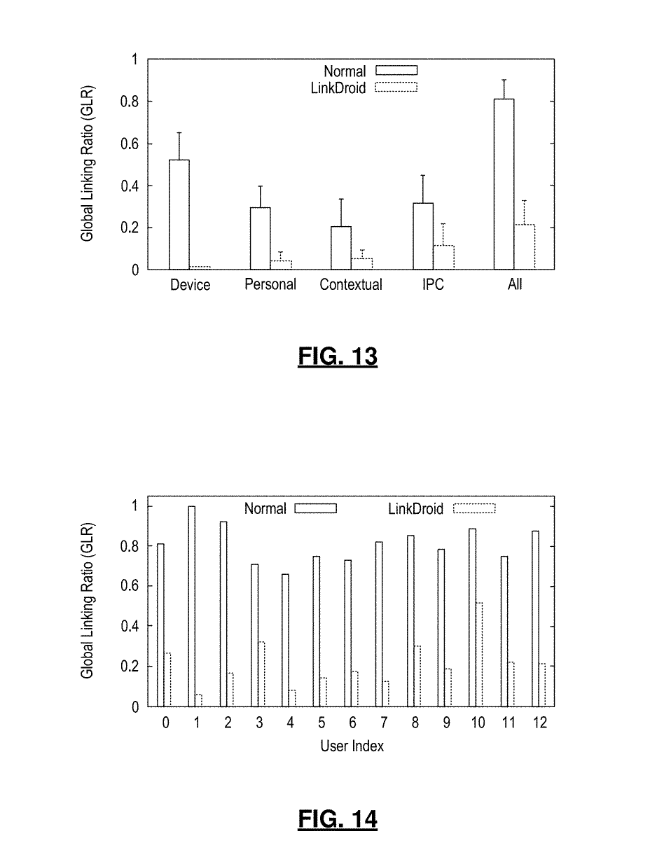

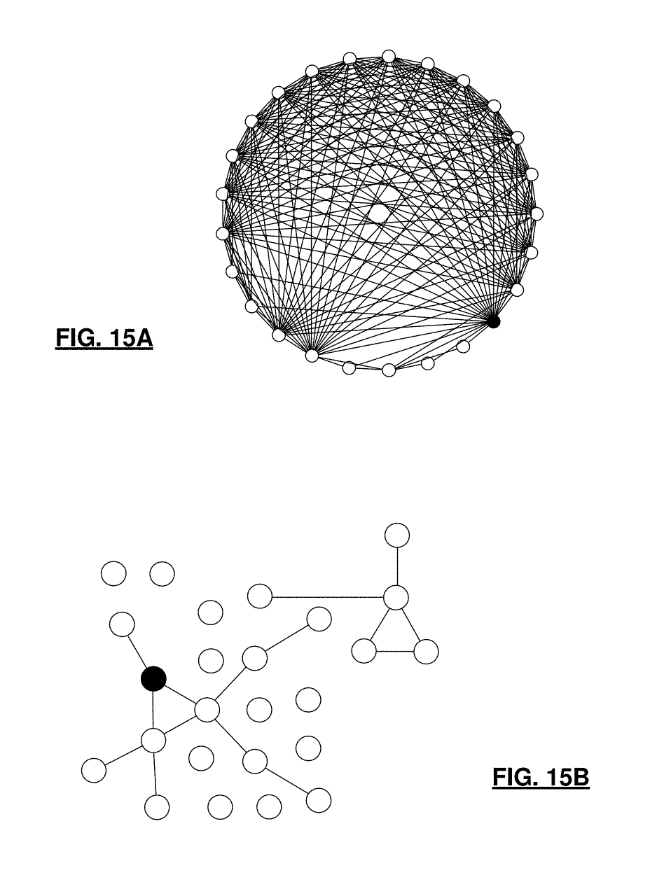

After applying LinkDroid, it was found that the Global Linking Ratio (GLR) dropped from 81% to 21%. FIG. 13 shows the breakdown of linkability drop in different categories of sources. The majority of the remaining linkability comes from inter-app communications, most of which are genuine from the user's perspective. Not only fewer apps are linkable, LinkDroid also makes it harder for an adversary to aggregate information from two linkable apps. The Global Linking Effort (GLE) increases significantly after applying LinkDroid: from 0.22 to 0.68. Specifically, the percentage of apps that are directly linkable to Facebook dropped from 86% to 18%. FIG. 15 gives an illustrative example of how DLG changes after applying LinkDroid. It is noted that the effectiveness of LinkDroid differs across users, as shown in FIG. 14. In general, LinkDroid is more effective for the users who have diverse mobility patterns, are cautious about sharing information across apps and/or maintain different accounts for different services.

LinkDroid takes VPN as a plug-in solution to obfuscate network identifiers. The potential drawback of using VPN is its influence on device energy consumption and network latency. The device energy consumption of using VPN is measured on a Samsung Galaxy 4 device, with Monsoon Power Monitor. Specifically, two network-intensive workloads were tested: online videos and browsing. A 5% increase in energy consumption was observed for the first workload, and no observable difference for the second. To measure the network latency, the ping time (average of 10 trials) was measured to Alexa Top 20 domains and found a 13% increase (17ms). These results indicate that the overhead of using VPN on smartphone device is noticeable but not significant. Seven of 13 participants in the evaluation were willing to use VPN services to achieve better privacy.

In this disclosure, a new metric, linkability; to quantify the ability of different apps to link and aggregate their usage behaviors was presented. This metric, albeit useful, is only a coarse upper-bound of the actual privacy threat, especially in the case of IPCs. Communication between two apps does not necessarily mean that they have conducted, or are capable of conducting, information aggregation. However, deciding on the actual intention of each IPC is by itself a difficult task. It requires an automatic and extensible way of conducting semantic introspection on IPCs.

LinkDroid aims to reduce the linkability introduced covertly without the user's consent or knowledge—it couldn't and doesn't try to eliminate the linkability explicitly introduced by users. For example, a user may post photos of himself or exhibit very identifiable purchasing behavior in two different apps, thus establishing linkability. This type of linkability is app-specific, domain-dependent and beyond the control of LinkDroid. Identifiability or linkability of these domain-specific usage behaviors are of particular interest to other areas, such as anonymous payment, anonymous query processing and data anonymization techniques.

The list of identifying information considered in this disclosure is well-formatted and widely-used. These ubiquitous identifiers contribute the most to information aggregation, since they are persistent and consistent across different apps. LinkDroid can easily include other types of identifying information, such as walking patterns and microphone signatures, as long as a dear definition is given.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for identifying usage behavior amongst applications on a computing device, comprising:
instrumenting a component of an operating system with an app monitor, where the operating system is executing on the computing device;
detecting, by the app monitor, access to certain identifying information for a user of a given application, where the given application accesses the certain identifying information during runtime of the given application and the app monitor is implemented by processor readable instructions executed by a computing processor of the computing device;
accessing, by the app monitor, a linkability graph stored in a data store of the computing device, where the linkability graph is an undirected graph having a plurality of nodes, where each node represents an application installed on the computing device and each node specifies identifying information accessible to the corresponding application;
identifying, by the app monitor, nodes in the linkability graph that specify the certain identifying information accessed by the given application; and
creating, by the app monitor, an edge between node representing the given application in the linkability graph and each of the identified nodes in the linkability graph.

2. The computer-implemented method of claim 1 wherein the certain identifying information for the user is selected from a group consisting of an identifier for the computing device, an identifier for personal information associated with the user and contextual information associated with the user.

3. The computer-implemented method of claim 1 further comprises detecting, by a linkability service, installation of an application of the computing device; and
creating, by the linkability service, a node in the linkability graph, where the node represents the application.

4. The computer-implemented method of claim 1 further comprises
detecting, by a linkability service, communication between the given application and a second application installed on the computing device; and
creating, by the linkability service, an edge between node representing the given application and node representing the second application.

5. The computer-implemented method of claim 1 further comprises detecting, by a linkability service, installation of the given application on the computing device;
receiving, by the linkability service, identifier for the given application;
encoding, by the linkability service, the identifier to form a masked identifier; and
storing, by the linkability service, the masked identifier in a data store.

6. The computer-implemented method of claim 1 further comprises notifying, by a linkability service, the user of the given application that the given application is accessing identifying information for the user, where notifying the user is performed in response to detecting access to certain identifying information for a user of a given application.

7. The computer-implemented method of claim 6 wherein the notification to the user includes a prompt to allow access to the identifying information for the user and a prompt to deny access to the identifying information for the user.

8. The computer-implemented method of claim 7 further comprises receiving, by the linkability service, an input from the user to deny access and taking steps to prevent access to the identifying information for the user by the given application.

9. The computer-implemented method of claim 1 further comprises instrumenting functions in system services with an app monitor, where the functions return identifying information and the system services are provided by the operating system of the computing device.

10. A system for reducing usage behavior amongst applications on a computing device, comprising:
a decision database that stores user decisions to allow or deny access to identifying information for the user of an application, where the decision database resides on the computing device;
an app monitor instrumented in a component of an operating system executing on the computing device, wherein the app monitor detects access by a given application to certain identifying information for the user of the given application and provides an indicator of the detected access by the given application to a linkability service; and
the linkability service is implemented as a system service of the operating system and configured to receive the indicator from the app monitor regarding access by the given application to certain identifying information and, in response to receiving the indicator from the app monitor, queries the decision database for a user's decision regarding access by the given application to certain identifying information,
wherein the linkability service, in absence of a user's decision in the decision database, notifies the user of the given application that the given application is accessing certain identifying information for the user and identities other applications on the computing device that are linked to the given application.

11. The system of claim 10 further comprises a linkability graph stored in a data store of the computing device, wherein the linkability graph is an undirected graph having a plurality of nodes, each node represents an application installed on the computing device, each node specifies identifying information accessible to the corresponding node and each edge interconnecting two nodes in the graph represents a link between the two applications.

12. The system of claim 11 wherein the linkability service identifies applications that are linked together using the linkability graph.

13. The system of claim 11 wherein the linkability service, in absence of a user's decision in the decision database, prompts the user to allow access to the identifying information or to deny access to the identifying information and, in response to receiving an input to deny access, obfuscates the certain identifying information being accessed by the given application.

14. The system of claim 13 wherein the linkability service quantifies risk associated with allowing access to the identifying information and presents the risk to the user, along with the notification that the given application is accessing the certain identifying information, where the risk is a function of linking ratio and linking effort, the linking ratio of the given application is defined as the number of apps linkable to the given application divided by the total number of applications installed on the computing device, and the linking effort of the given application is defined as average gap between the given application and all of the apps it is linked to in the linkability graph.

15. The system of claim 11 wherein the linkability service identifies nodes in the linkability graph that specify the certain identifying information and creates an edge between node representing the given application and each of the identified nodes in the linkability graph.

16. The system of claim 11 wherein the linkability service detects communication between the given application and a second application installed on the computing device and creates an edge between node representing the given application and node representing the second application.

17. The system of claim 11 wherein the linkability service detects installation of a particular application on the computing device and creates a node in the linkability graph, where the node represents the particular application.

18. The system of claim 10 wherein the certain identifying information for the user is selected from a group consisting of an identifier for the computing device, an identifier for personal information associated with the user and contextual information associated with the user.
